(19) United States
(12) Patent Application Publication
(10) Pub. No.: US 2024/0202608 A1
(43) Pub. Date: Jun. 20, 2024

(54) CHARGING FACILITY RESERVATION SYSTEM AND ELECTRIC VEHICLE

(71) Applicant: SUBARU CORPORATION, Tokyo (JP)

(72) Inventor: Hideaki KATO, Tokyo (JP)

(21) Appl. No.: 18/533,905

(22) Filed: Dec. 8, 2023

(30) Foreign Application Priority Data
Dec. 16, 2022 (JP) 2022-201653

(51) Int. Cl. G06Q 10/02; G01C 21/34

(52) U.S. Cl. CPC G06Q 10/02; G01C 21/3469

(57) ABSTRACT

A charging facility reservation system includes an electric vehicle and a server. The electric vehicle includes a route calculator, a current position obtainer, an expected arrival time calculator, and a processor. The route calculator is configured to calculate a traveling route along which a charging facility is set as a stopover point. The current position obtainer is configured to acquire a current position of the electric vehicle. The expected arrival time calculator is configured to calculate an expected arrival time at which the electric vehicle is expected to arrive at the charging facility, based on the current position. The processor is configured to make a temporary reservation of the charging facility set as the stopover point by the route calculator, and cancel all or a part of the temporary reservation when the expected arrival time exceeds a use start time of the charging facility set upon making the temporary reservation.

### CROSS-REFERENCE TO RELATED APPLICATIONS

The present application claims priority from Japanese Patent Application No. 2022-201653 filed on Dec. 16, 2022, the entire contents of which are hereby incorporated by reference.

### BACKGROUND

The disclosure relates to a charging facility reservation system and an electric vehicle.

A vehicle such as an electric vehicle or a plug-in hybrid vehicle having a storage battery chargeable by an external power source has become popular in recent years from a viewpoint of environmental protection.

In order to enjoy long-distance driving by the vehicle such as the electric vehicle, it may sometimes be necessary to charge the storage battery. However, because a place and the number of charging facilities are limited, it is necessary for a driver who drives the vehicle to make a reservation of use of the charging facility in advance.

For example, Japanese Unexamined Patent Application Publication (JP-A) No. 2012-190407 discloses a technique related to a reservation of use of a charging facility. The technique makes a temporary reservation of a charging facility based on data such as a current position of an electric vehicle or a remaining charge amount of a storage battery, and fixes a reservation when a distance between the current position of the electric vehicle and the temporarily reserved charging facility approaches within a predetermined distance.

### SUMMARY

An aspect of the disclosure provides a charging facility reservation system that includes an electric vehicle and a server. The electric vehicle includes a route calculator, a current position obtainer, an expected arrival time calculator, and a processor. The route calculator is configured to calculate a traveling route along which a charging facility is set as a stopover point, based on a distance in which the electric vehicle is able to cruise. The current position obtainer is configured to acquire a current position of the electric vehicle. The expected arrival time calculator is configured to calculate an expected arrival time at which the electric vehicle is expected to arrive at the charging facility, based on the current position of the electric vehicle. The processor is configured to make a temporary reservation of the charging facility set as the stopover point by the route calculator, and cancel all or a part of the temporary reservation when the expected arrival time exceeds a use start time of the charging facility set upon making the temporary reservation. The server is communicably coupled to the electric vehicle and includes a transceiver and a reservation manager. The transceiver is configured to transmit and receive reservation data on the temporary reservation of the charging facility. The reservation manager is configured to manage use reservation of the charging facility, based on the reservation data.

An aspect of the disclosure provides an electric vehicle that includes a route calculator, a current position obtainer, an expected arrival time calculator, and a processor. The route calculator is configured to calculate a traveling route along which a charging facility is set as a stopover point, based on a distance in which the electric vehicle is able to cruise. The current position obtainer is configured to acquire a current position of the electric vehicle. The expected arrival time calculator is configured to calculate an expected arrival time at which the electric vehicle is expected to arrive at the charging facility, based on the current position of the electric vehicle. The processor is configured to make a temporary reservation of the charging facility set as the stopover point by the route calculator, and cancel all or a part of the temporary reservation when the expected arrival time exceeds a use start time of the charging facility set upon making the temporary reservation.

An aspect of the disclosure provides a charging facility reservation system that includes an electric vehicle and a server. The electric vehicle includes a current position obtainer configured to acquire a current position of the electric vehicle. The server is communicably coupled to the electric vehicle and includes a transceiver, a route calculator, an expected arrival time calculator, a server processor, and a reservation manager. The transceiver is configured to receive data on a distance in which the electric vehicle is able to cruise and data on the current position of the electric vehicle. The route calculator is configured to calculate a traveling route along which a charging facility is set as a stopover point, based on the distance in which the electric vehicle is able to cruise. The expected arrival time calculator is configured to calculate an expected arrival time at which the electric vehicle is expected to arrive at the charging facility, based on the current position of the electric vehicle. The server processor is configured to make a temporary reservation of the charging facility set as the stopover point by the route calculator, and cancel all or a part of the temporary reservation when the expected arrival time exceeds a use start time of the charging facility set upon making the temporary reservation. The reservation manager is configured to manage use reservation of the charging facility, based on reservation data on the temporary reservation derived from the server processor.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of a charging facility reservation system according to one example embodiment of the disclosure.

FIG. 2 is a diagram illustrating a configuration of an electric vehicle illustrated in FIG. 1.

FIG. 3 is a diagram illustrating a configuration of a server illustrated in FIG. 1.

FIG. 4 is a diagram illustrating a reservation frame of temporary reservations of charging facilities illustrated in FIG. 1.

FIG. 5 is a flowchart illustrating a process to be performed by the charging facility reservation system illustrated in FIG. 1.

FIG. 6 is a diagram illustrating a configuration of a charging facility reservation system according to one example embodiment of the disclosure.

FIG. 7 is a diagram illustrating a configuration of an electric vehicle illustrated in FIG. 6.

FIG. 8 is a diagram illustrating a configuration of a server illustrated in FIG. 6.

FIG. 9 is a flowchart of a process to be performed by the charging facility reservation system illustrated in FIG. 6.

### DETAILED DESCRIPTION

A technique disclosed in JP-A No. 2012-190407 does not cause a temporary reservation of a charging facility to be cancelled even when a vehicle is unable to approach the charging facility by the time at which use of the temporarily reserved charging facility is started due to, for example, a traffic congestion or an accident of a road, which can lead to a decrease in an operation efficiency of the temporarily reserved charging facility.

It is desirable to provide a charging facility reservation system and an electric vehicle that make it possible to improve an operation efficiency of a charging facility.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### EXAMPLE EMBODIMENTS

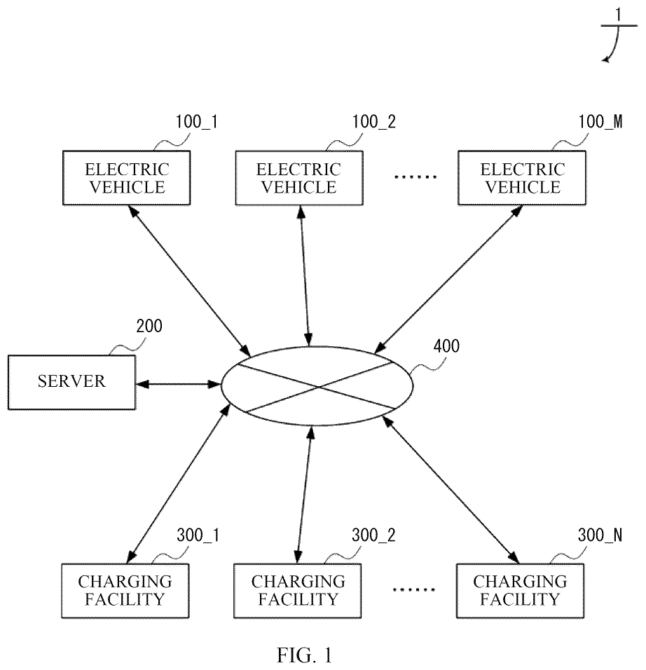

A charging facility reservation system according to an example embodiment will be described with reference to FIGS. 1 to 9.

### First Example Embodiment

A charging facility reservation system 1 according to a first example embodiment will be described with reference to FIGS. 1 to 5.

### [Configuration of Charging Facility Reservation System 1]

Referring to FIG. 1, the charging facility reservation system 1 according to the example embodiment may include: electric vehicles 100_1 to 100_M serving as own vehicles; a server 200; charging facilities 300_1 to 300_N; and a network 400.

In the following description, the electric vehicles 100_1 to 100_M may be collectively referred to as an “electric vehicle 100”, and the charging facilities 300_1 to 300_N may be collectively referred to as a “charging facility 300”.

The electric vehicle 100 may include a storage battery chargeable by an external power source, and charge the storage battery at the charging facility 300.

The server 200 may be communicably coupled to the electric vehicle 100 and the charging facility 300 via the network 400, and manage a reservation of use of the charging facility 300.

The network 400 may be any network adapted for a communication between multiple devices. The network 400 may be, for example but not limited to, an Internet network.

The example configurations of the electric vehicle 100 and the server 200 will be described later.

### [Configuration of Electric Vehicle 100]

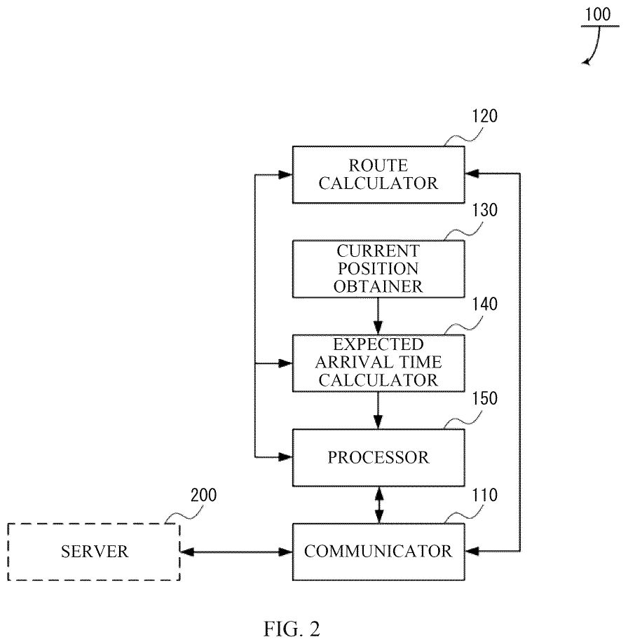

Referring to FIG. 2, the electric vehicle 100 includes a communicator 110, a route calculator 120, a current position obtainer 130, an expected arrival time calculator 140, and a processor 150.

The communicator 110 may be, for example, any known wireless communication module. The communicator 110 may serve as an interface for the electric vehicle 100 to communicate with the server 200 via the network 400.

The route calculator 120 calculates a traveling route along which the charging facility 300 is set as a stopover point, based on a distance in which the electric vehicle 100 is able to cruise. In one embodiment, the route calculator 120 may serve as a “calculator”.

For example, when a driver who drives the electric vehicle 100 sets a traveling route to a destination and where it is not possible or difficult to travel to the destination in a current state of charge of the storage battery, the route calculator 120 may calculate the traveling route to the destination by setting, as the stopover point, the charging facility 300 that is within a distance in which the electric vehicle 100 is able to cruise in the current state of charge of the storage battery.

The route calculator 120 may determine the charging facility 300 to be set as the stopover point based on data, acquired from the server 200, on the charging facility 300 that is within the distance in which the electric vehicle 100 is able to cruise in the current state of charge of the storage battery, and thereby calculate the traveling route. Non-limiting examples of the data on the charging facility 300 may include position data of the charging facility and a current status of reservation.

The route calculator 120 may transmit data on the charging facility 300 set as the stopover point to the later-described expected arrival time calculator 140 and processor 150. Non-limiting examples of the data on the charging facility 300 set as the stopover point may include an individual identification number of the charging facility 300 and position data of the charging facility 300.

In some embodiments, the route calculator 120 may be a navigation device provided in the electric vehicle 100. In some embodiments, the route calculator 120 may be a smartphone carried by the driver.

The current position obtainer 130 acquires a current position of the electric vehicle 100.

The current position obtainer 130 may be, for example but not limited to, a GPS receiver. For example, the current position obtainer 130 may acquire the current position of the electric vehicle 100 and transmit data on the acquired current position to the later-described expected arrival time calculator 140. In one embodiment, the current position obtainer 130 may serve as a “receiver”.

The expected arrival time calculator 140 calculates an expected arrival time at which the electric vehicle 100 is expected to arrive at the charging facility 300, based on the current position of the electric vehicle 100.

For example, the expected arrival time calculator 140 may calculate the expected arrival time at which the electric vehicle 100 is expected to arrive at the charging facility 300, based on a traveling speed. The traveling speed may be calculated based on the current position data of the electric vehicle 100 received from the current position obtainer 130 and the position data of the charging facility 300 set by the route calculator 120 as the stopover point. The traveling speed may take into consideration a traveling distance and a traveling state of a route from the current position of the electric vehicle 100 to the charging facility 300.

The expected arrival time calculator 140 may transmit the calculated data on the expected arrival time to the later-described processor 150.

The expected arrival time calculator 140 may calculate the expected arrival time periodically (for example but not limited to, every 3 minutes) and transmit the calculated expected arrival time to the processor 150.

The processor 150 may control an operation of the electric vehicle 100 as a whole in accordance with a control program stored in an unillustrated storage such as a read only memory (ROM).

In the example embodiment, the processor 150 makes a temporary reservation of the charging facility 300 set as the stopover point by the route calculator 120, and cancels all or a part of the temporary reservation when the expected arrival time exceeds the use start time of the charging facility 300 set upon making the temporary reservation.

The temporary reservation of the charging facility 300 according to the example embodiment will be described.

The temporary reservation may refer to designating any one of the charging facilities 300_1 to 300_N and registering a charging schedule of the electric vehicle 100 in the later-described server 200.

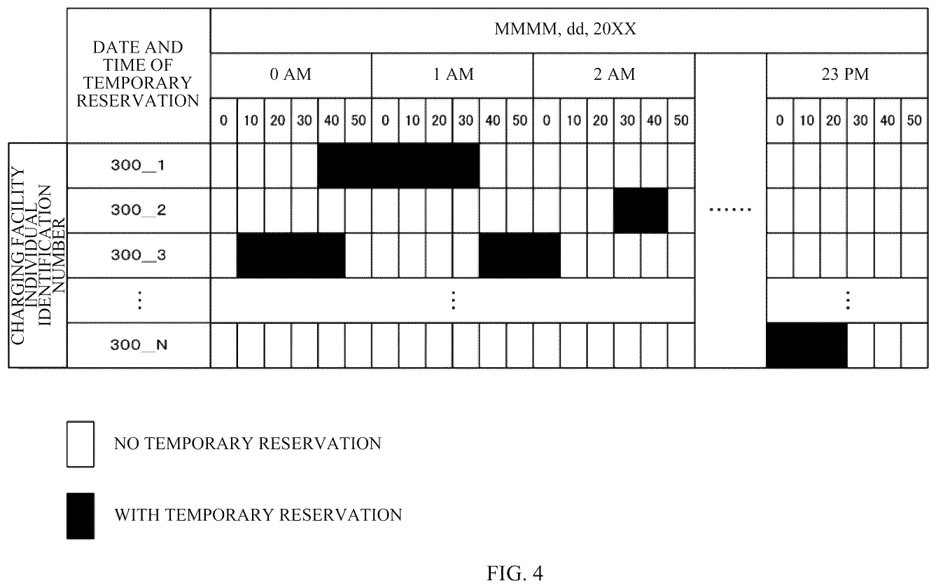

Referring to FIG. 4, the temporary reservation may include a reservation frame in which one frame is 10 minutes, for example. The temporary reservation of the charging facility 300 may be made by transmitting data to the server 200. Non-limiting examples of the data may include the individual identification number of the charging facility 300 to be temporarily reserved, the use start time of the charging facility 300 to be temporarily reserved, the scheduled use time of the charging facility 300 to be temporarily reserved, and the personal identification number of a user.

The processor 150 may compare the use start time determined based on the expected arrival time calculated by the expected arrival time calculator 140 when the route calculator 120 has calculated the traveling route to the destination, with the expected arrival time calculated again by the expected arrival time calculator 140 while the electric vehicle 100 travels on the traveling route toward the charging facility 300 set as the stopover point. The processor 150 executes a process of canceling all or a part of the temporary reservation when the expected arrival time exceeds the use start time.

For example, when the processor 150 determines that the electric vehicle 100 is unable to arrive at the charging facility 300 by the use start time set upon making the temporary reservation due to, for example, an accident or a traffic congestion of a road, the processor 150 may cancel all of the temporary reservation of the charging facility 300 set as the stopover point, or may cancel a part of the temporary reservation. Non-limiting examples of cancelling a part of the temporary reservation may include changing the time of the temporary reservation.

The processor 150 may set, as the use start time, the expected arrival time calculated by the expected arrival time calculator 140 when, for example, the route calculator 120 has calculated the traveling route or the driver has set the destination, and may execute the temporary reservation accordingly.

In some embodiments, the processor 150 may set the use start time to a time that has a time margin with respect to the expected arrival time calculated by the expected arrival time calculator 140. For example, the processor 150 may set the use start time that is 10 minutes after the expected arrival time calculated by the expected arrival time calculator 140.

### [Configuration of Server 200]

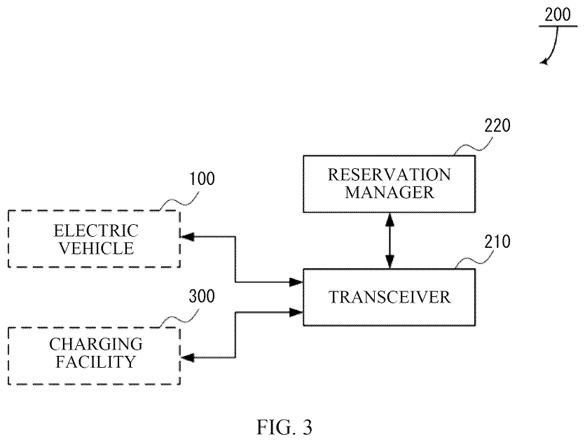

Referring to FIG. 3, the server 200 includes a transceiver 210 and a reservation manager 220.

The transceiver 210 transmits and receives reservation data on the temporary reservation of the charging facility 300.

For example, the transceiver 210 may be coupled to the electric vehicle 100, and transmit and receive the reservation data on the temporary reservation of the charging facility 300 to and from the electric vehicle 100.

Non-limiting examples of the reservation data on the temporary reservation of the charging facility 300 may include the individual identification number of the charging facility 300 to be temporarily reserved, the use start time of the charging facility 300 to be temporarily reserved, the use time of the charging facility 300 to be temporarily reserved, the personal identification number of the user, and the vacancy data of the charging facility 300 referred to when the route calculator 120 calculates the traveling route.

The reservation manager 220 manages use reservation data of the charging facility 300, based on the reservation data.

For example, the reservation manager 220 may store, in an unillustrated memory, the reservation data on the temporary reservation received from the processor 150 of one or more of the electric vehicles 100_1 to 100_M, and update the use reservation data for each of the charging facilities 300_1 to 300_N. Non-limiting examples of the reservation data on the temporary reservation may include the individual identification number of the charging facility 300, the use start time of the charging facility 300, the scheduled use time of the charging facility 300, and the personal identification number of the user.

When an instruction to cancel all or a part of the temporary reservation is received from the processor 150 of one or more of the electric vehicles 100_1 to 100_M, the reservation manager 220 may update the use reservation data of the charging facility 300 stored in the memory.

In some embodiments, the reservation manager 220 may execute a process of making the temporary reservation a non-temporary reservation, for example, 15 minutes before the use start time registered at the time of making the temporary reservation, and may not accept the cancellation of the use reservation after making the temporary reservation the non-temporary reservation.

### [Process of Charging Facility Reservation System 1]

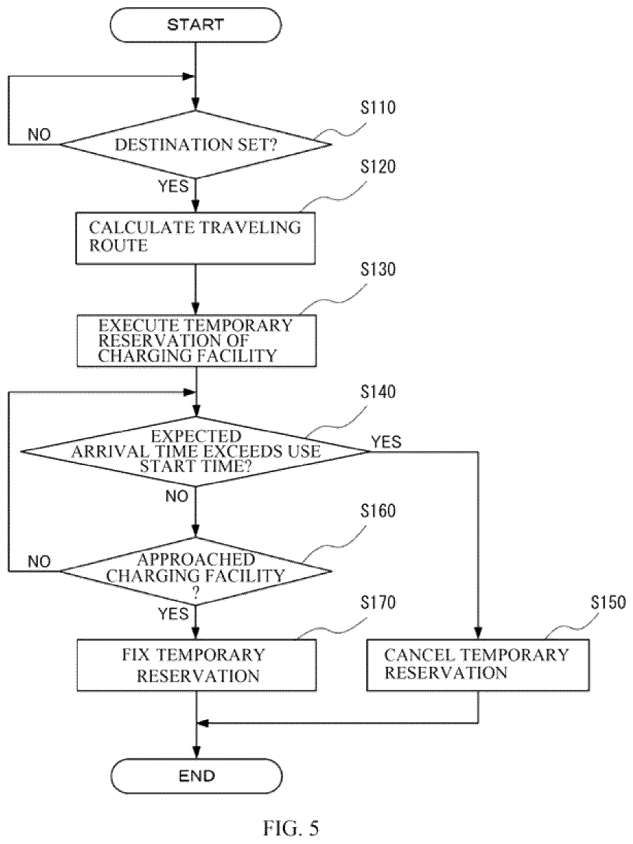

An example process to be performed by the charging facility reservation system 1 will be described with reference to FIG. 5.

The processor 150 may determine whether an occupant of the electric vehicle 100 has set the destination (step S110).

If the processor 150 determines that the occupant of the electric vehicle 100 has not set the destination (“NO” in step S110), the processor 150 may return the process and shift to a standby state.

If the processor 150 determines that the occupant of the electric vehicle 100 has set the destination (“YES” in step S110), the route calculator 120 may calculate the traveling route along which the charging facility 300 is set as the stopover point (step S120).

The processor 150 may execute the temporary reservation of the charging facility 300 set by the route calculator 120 as the stopover point (step S130).

For example, the processor 150 may determine the use start time of the charging facility 300, based on the expected arrival time of arrival at the charging facility 300 acquired from the expected arrival time calculator 140, in order to make the temporary reservation of the charging facility 300 set as the stopover point.

Thereafter, the processor 150 may transmit, to the server 200, the data on the temporary reservation including, for example but not limited to, the individual identification number of the charging facility 300 set as the stopover point, the use start time of the charging facility 300 set as the stopover point, the scheduled use time of the charging facility 300 set as the stopover point, and the personal identification number of the user, and execute the temporary reservation.

The server 200 may update the use reservation data of the charging facility 300 stored in the unillustrated memory, based on the received data on the temporary reservation.

The processor 150 may determine whether the expected arrival time exceeds the use start time of the charging facility 300 set when the temporary reservation is made (step S140).

If the processor 150 determines that the expected arrival time exceeds the use start time of the charging facility 300 set when the temporary reservation is made (“YES” in step S140), the processor 150 may execute a process of cancelling the temporary reservation (step S150), and end the process.

For example, the processor 150 may transmit, to the server 200, an instruction to cancel the temporary reservation and temporary reservation data to be cancelled. Non-limiting examples of the temporary reservation data to be cancelled may include the individual identification number of the charging facility 300, the use start time of the charging facility 300, the scheduled use time of the charging facility 300, and the personal identification number of the user.

Thereafter, the server 200 may update the temporary reservation data of the charging facility 300, based on the received temporary reservation data.

If the processor 150 determines that the expected arrival time does not exceed the use start time of the charging facility 300 set when the temporary reservation is made (“NO” in step S140), the processor 150 may determine whether the electric vehicle 100 has approached the charging facility 300 (step S160).

In some embodiments, the processor 150 may determine that the electric vehicle 100 has approached the charging facility 300, when a distance of the traveling route from the current position of the electric vehicle 100 to the charging facility 300 set as the stopover point is within a predetermined distance. In some embodiments, the processor 150 may determine that the electric vehicle 100 has approached the charging facility 300, when the time required for the electric vehicle 100 to travel from the current position of the electric vehicle 100 to the charging facility 300 set as the stopover point is within a predetermined time.

If the processor 150 determines that the electric vehicle 100 has not approached the charging facility 300 (“NO” in step S160), the processor 150 may return the process to step S140 and continue the process.

If the processor 150 determines that the electric vehicle 100 has approached the charging facility 300 (“YES” in step S160), the processor 150 may execute a process of fixing the temporary reservation (step S170) and end the process.

For example, when the processor 150 determines that the electric vehicle 100 has sufficiently approached the charging facility 300 and that it is possible to use the charging facility 300 as scheduled from the use start time set when the temporary reservation is made, the processor 150 may execute the process of making the temporary reservation the non-temporary reservation.

In one example, the processor 150 may transmit, to the server 200, an instruction to perform the non-temporary reservation and the temporary reservation data to perform the non-temporary reservation. Non-limiting examples of the temporary reservation data to perform the non-temporary reservation may include the individual identification number of the charging facility 300 to be non-temporarily reserved, the use start time of the charging facility 300 to be non-temporarily reserved, the scheduled use time of the charging facility 300 to be non-temporarily reserved, and the personal identification number of the user.

Thereafter, the server 200 may update the use reservation data of the charging facility 300 based on the received data, and may not accept the subsequent use cancellation of the charging facility 300.

### Workings and Example Effects

The processor 150 of the charging facility reservation system 1 according to the example embodiment makes the temporary reservation of the charging facility 300 set as the stopover point by the route calculator 120, and cancels all or a part of the temporary reservation when the expected arrival time of the electric vehicle 100 to the charging facility 300 exceeds the use start time set upon making the temporary reservation.

For example, the processor 150 may calculate the expected arrival time to the charging facility 300, and execute the process of canceling the temporary reservation of the charging facility 300 set as the stopover point, when the processor 150 determines that it is not possible or difficult for the electric vehicle 100 to arrive at the charging facility 300 by the use start time set at the time of making the temporary reservation.

This configuration allows another electric vehicle 100 to use the cancelled charging facility 300, which helps to improve an operation efficiency of the charging facility 300.

In some embodiments, the processor 150 may monitor that it is possible for the electric vehicle 100 to arrive at the charging facility 300 by the use start time set at the time of the temporary reservation, and execute the process of making the temporary reservation the non-temporary reservation when the electric vehicle 100 is sufficiently approached the temporarily reserved charging facility 300.

This configuration allows a probability that the charging facility 300 is used as scheduled from the use start time to be higher, which helps to improve the operation efficiency of the charging facility 300.

### Second Example Embodiment

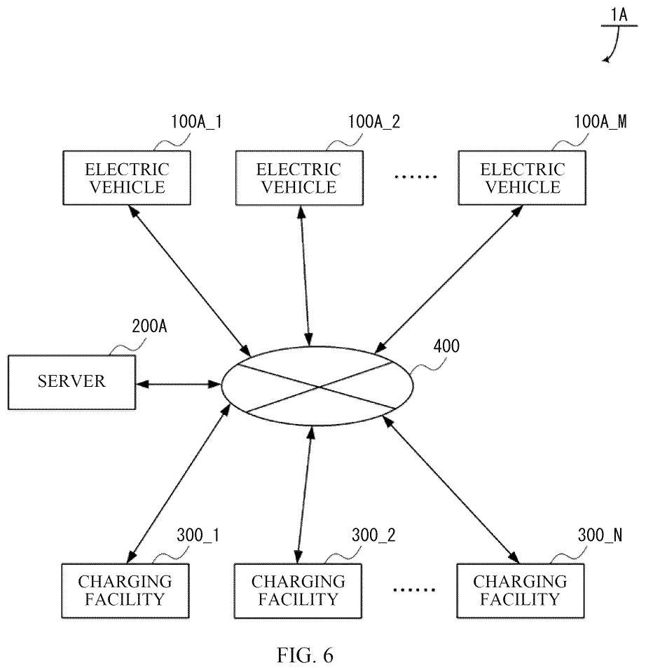

A description is given of a charging facility reservation system 1A according to a second example embodiment of the disclosure with reference to FIGS. 6 to 9.

It should be noted that elements denoted with reference numerals that are same as those of the first example embodiment may have the same operations as those of the first example embodiment and they will not be described in detail.

### [Configuration of Charging Facility Reservation System 1A]

Referring to FIG. 6, the charging facility reservation system 1A according to the example embodiment may include: electric vehicles 100A_1 to 100A_M serving as own vehicles; a server 200A; the charging facilities 300_1 to 300_N; and the network 400.

In the following description, the electric vehicles 100A_1 to 100A_M may be collectively referred to as an “electric vehicle 100A”.

[Configuration of Electric vehicle 100A]

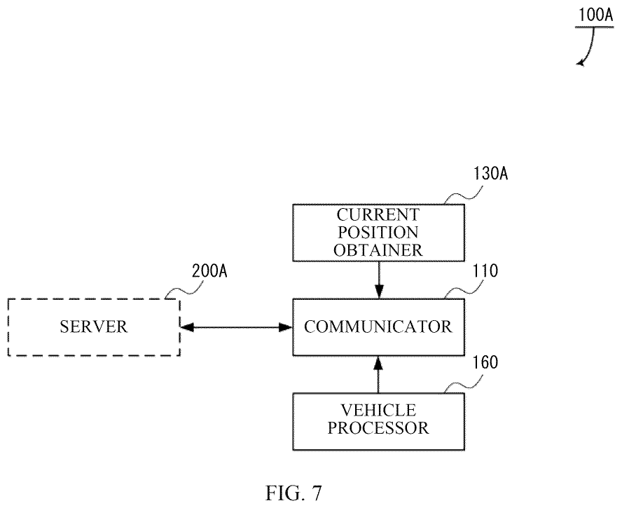

Referring to FIG. 7, the electric vehicle 100A may include the communicator 110, a current position obtainer 130A, and a vehicle processor 160.

The current position obtainer 130A acquires a current position of the electric vehicle 100A.

The current position obtainer 130A may be, for example but not limited to, a GPS receiver. For example, the current position obtainer 130A may acquire the current position of the electric vehicle 100A and transmit data on the acquired current position to the server 200A. In one embodiment, the current position obtainer 130A may serve as a “receiver”.

The vehicle processor 160 may control an operation of the electric vehicle 100A as a whole in accordance with a control program stored in an unillustrated storage such as a read only memory (ROM).

In the example embodiment, when a driver who drives the electric vehicle 100A sets a destination, the vehicle processor 160 may transmit position data on the destination to the server 200A.

The vehicle processor 160 may calculate a distance in which the electric vehicle 100A is able to cruise, based on a current state of charge of a storage battery, and transmit a result of the calculation to the server 200A.

### [Configuration of Server 200A]

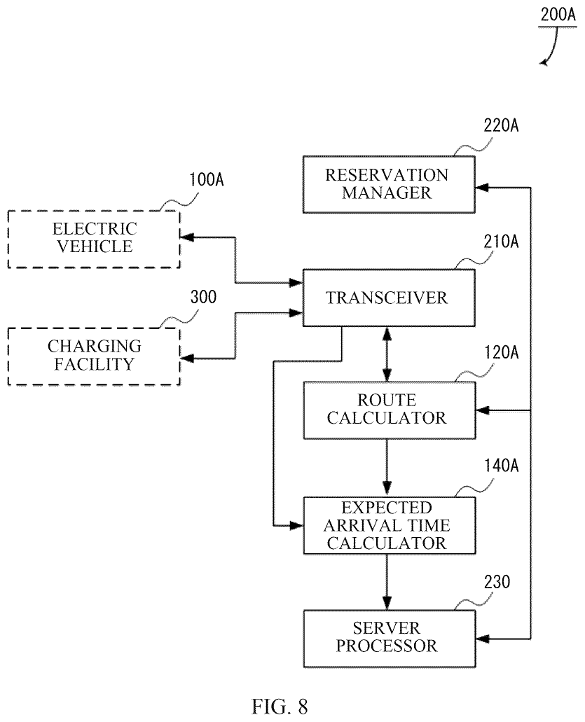

Referring to FIG. 8, the server 200A includes a route calculator 120A, an expected arrival time calculator 140A, a transceiver 210A, a reservation manager 220A, and a server processor 230.

The route calculator 120A calculates a traveling route along which the charging facility, positioned in the distance in which the electric vehicle 100A is able to cruise 300, is set as a stopover point.

For example, the route calculator 120A may receive data on the distance in which the electric vehicle 100A is able to cruise, data on the current position, and the position data of the destination from the electric vehicle 100A. When a traveling distance from the current position to the destination is longer than the distance in which the electric vehicle 100A is able to cruise, the route calculator 120A may calculate the traveling route to the destination by setting, as the stopover point, the charging facility 300 that is within the distance in which the electric vehicle 100A is able to cruise.

The route calculator 120A may transmit data on the charging facility 300 set as the stopover point to the later-described expected arrival time calculator 140A and server processor 230. Non-limiting examples of the data on the charging facility 300 set as the stopover point may include an individual identification number of the charging facility 300 and position data of the charging facility 300.

The expected arrival time calculator 140A calculates an expected arrival time at which the electric vehicle 100A is expected to arrive at the charging facility 300, based on the data on the current position received from the electric vehicle 100A.

The expected arrival time calculator 140A may transmit the calculated expected arrival time to the later-described server processor 230.

The transceiver 210A receives the data on the distance in which the electric vehicle 100A is able to cruise and the data on the current position of the electric vehicle 100A.

For example, the transceiver 210A may be coupled to the electric vehicle 100A, and receive the data on the distance in which the electric vehicle 100A is able to cruise, the data on the current position of the electric vehicle 100A, and the data on the destination. The transceiver 210A may transmit the received pieces of data to the route calculator 120A.

The transceiver 210A may transmit, to the electric vehicle 100A, data on the traveling route to the destination received from the route calculator 120A.

The reservation manager 220A manages use reservation data of the charging facility 300, based on reservation data on a temporary reservation received from the later-described server processor 230.

For example, the reservation manager 220A may store, in an unillustrated memory, the reservation data on the temporary reservation received from the server processor 230, and update the use reservation data for each of the charging facilities 300_1 to 300_N. Non-limiting examples of the reservation data on the temporary reservation may include the individual identification number of the charging facility 300, the use start time of the charging facility 300, the scheduled use time of the charging facility 300, and the personal identification number of a user.

When an instruction to cancel all or a part of the temporary reservation is received from the server processor 230, the reservation manager 220A may update the use reservation data of the charging facility 300 stored in the memory.

The server processor 230 may control an operation of the server 200A as a whole in accordance with a control program stored in an unillustrated storage such as a read only memory (ROM).

In the example embodiment, the server processor 230 makes a temporary reservation of the charging facility 300 set as the stopover point by the route calculator 120A, and cancels all or a part of the temporary reservation when the expected arrival time exceeds the use start time that is set upon making the temporary reservation.

For example, the server processor 230 may transmit, to the reservation manager 220A, the data including, for example but not limited to, the individual identification number of the charging facility 300 set as the stopover point, the use start time of the charging facility 300 set as the stopover point, the scheduled use time of the charging facility 300 set as the stopover point, and the personal identification number of the user, and make the temporary reservation.

The server processor 230 may compare the use start time determined based on the expected arrival time calculated by the expected arrival time calculator 140A when the route calculator 120A has calculated the traveling route to the destination, with the expected arrival time calculated again by the expected arrival time calculator 140A while the electric vehicle 100A travels on the traveling route toward the charging facility 300 set as the stopover point. The server processor 230 may transmit an instruction to cancel all or a part of the temporary reservation when the expected arrival time exceeds the use start time.

The server processor 230 may set, as the use start time, the expected arrival time calculated by the expected arrival time calculator 140A when, for example, the route calculator 120A has calculated the traveling route or the driver has set the destination, and may execute the temporary reservation accordingly.

### [Process of Charging Facility Reservation System 1A]

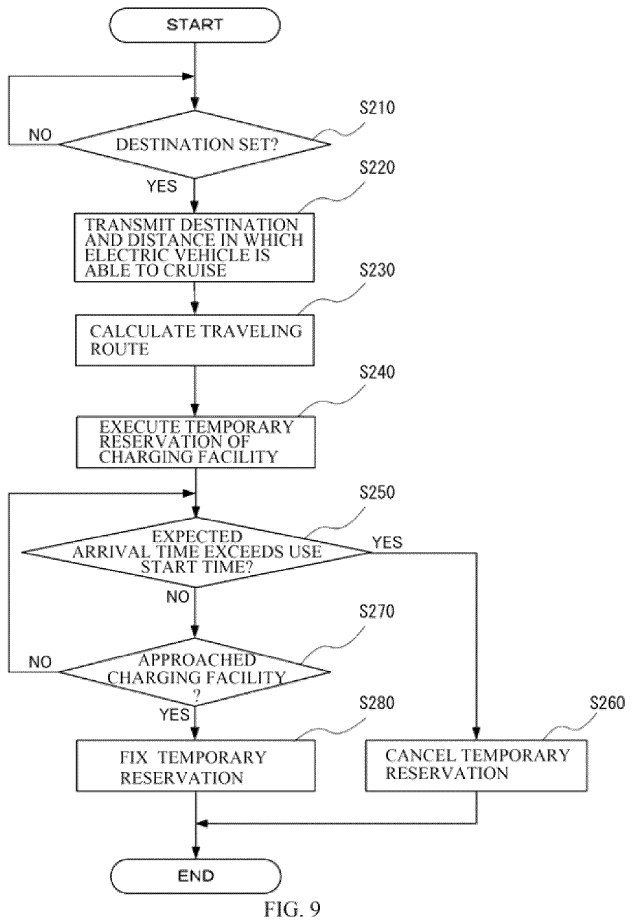

An example process to be performed by the charging facility reservation system 1A will be described with reference to FIG. 9.

The vehicle processor 160 may determine whether an occupant of the electric vehicle 100A has set the destination (step S210).

If the vehicle processor 160 determines that the occupant of the electric vehicle 100A has not set the destination (“NO” in step S210), the vehicle processor 160 may return the process and shift to a standby state.

If the vehicle processor 160 determines that the occupant of the electric vehicle 100A has set the destination (“YES” in step S210), the vehicle processor 160 may transmit, to the server 200A, the data on the destination set by the occupant and the data on the distance in which the electric vehicle 100A is able to cruise (step S220).

The route calculator 120A may calculate the traveling route along which the charging facility 300 is set as the stopover point, based on the data on the destination, the data on the distance in which the electric vehicle 100A is able to cruise, or both received from the electric vehicle 100A (step S230).

The server processor 230 may execute the temporary reservation of the charging facility 300 set by the route calculator 120A as the stopover point (step S240).

For example, the server processor 230 may determine the use start time of the charging facility 300, based on the expected arrival time of arrival at the charging facility 300 acquired from the expected arrival time calculator 140A, in order to make the temporary reservation of the charging facility 300 set as the stopover point.

Thereafter, the server processor 230 may transmit, to the reservation manager 220A, the data on the temporary reservation including, for example but not limited to, the individual identification number of the charging facility 300 set as the stopover point, the use start time of the charging facility 300 set as the stopover point, the scheduled use time of the charging facility 300 set as the stopover point, and the personal identification number of the user, and execute the temporary reservation.

The reservation manager 220A may update the use reservation data of the charging facility 300 stored in the unillustrated memory, based on the received reservation data on the temporary reservation.

The server processor 230 may determine whether the expected arrival time received from the expected arrival time calculator 140A exceeds the use start time of the charging facility 300 set when the temporary reservation is made (step S250).

If the server processor 230 determines that the expected arrival time exceeds the use start time of the charging facility 300 set when the temporary reservation is made (“YES” in step S250), the server processor 230 may execute a process of cancelling the temporary reservation (step S260), and end the process.

For example, the server processor 230 may transmit, to the reservation manager 220A, an instruction to cancel the temporary reservation and temporary reservation data to be cancelled. Non-limiting examples of the temporary reservation data to be cancelled may include the individual identification number of the charging facility 300, the use start time of the charging facility 300, the scheduled use time of the charging facility 300, and the personal identification number of the user.

Thereafter, the reservation manager 220A may update the use reservation data of the charging facility 300 stored in the memory, based on the received temporary reservation data.

If the server processor 230 determines that the expected arrival time does not exceed the use start time of the charging facility 300 set when the temporary reservation is made (“NO” in step S250), the server processor 230 may determine whether the electric vehicle 100A has approached the charging facility 300 (step S270).

In some embodiments, the server processor 230 may determine that the electric vehicle 100A has approached the charging facility 300, when a distance of the traveling route from the current position of the electric vehicle 100A to the charging facility 300 set as the stopover point is within a predetermined distance. In some embodiments, the server processor 230 may determine that the electric vehicle 100A has approached the charging facility 300, when the time required for the electric vehicle 100A to travel from the current position of the electric vehicle 100A to the charging facility 300 set as the stopover point is within a predetermined time.

If the server processor 230 determines that the electric vehicle 100A has not approached the charging facility 300 (“NO” in step S270), the server processor 230 may return the process to step S250 and continue the process.

If the server processor 230 determines that the electric vehicle 100A has approached the charging facility 300 (“YES” in step S270), the server processor 230 may execute a process of fixing the temporary reservation (step S280) and end the process.

For example, the server processor 230 may transmit, to the reservation manager 220A, an instruction to perform the non-temporary reservation and the temporary reservation data to perform the non-temporary reservation. Non-limiting examples of the temporary reservation data to perform the non-temporary reservation may include the individual identification number of the charging facility 300 to be non-temporarily reserved, the use start time of the charging facility 300 to be non-temporarily reserved, the scheduled use time of the charging facility 300 to be non-temporarily reserved, and the personal identification number of the user.

### Workings and Example Effects

The server processor 230 of the charging facility reservation system 1A according to the example embodiment makes the temporary reservation of the charging facility 300 set as the stopover point by the route calculator 120A, and cancels all or a part of the temporary reservation when the expected arrival time of the electric vehicle 100A to the charging facility 300 exceeds the use start time set upon making the temporary reservation.

For example, the server processor 230 may calculate the expected arrival time to the charging facility 300, and execute the process of canceling the temporary reservation of the charging facility 300 set as the stopover point, when the server processor 230 determines that it is not possible or difficult for the electric vehicle 100A to arrive at the charging facility 300 by the use start time set at the time of making the temporary reservation.

This configuration allows another electric vehicle 100A to use the cancelled charging facility 300, which helps to improve an operation efficiency of the charging facility 300.

In some embodiments, the server processor 230 may monitor whether it is possible for the electric vehicle 100A to arrive at the charging facility 300 by the use start time set at the time of the temporary reservation, and execute a process of making the temporary reservation the non-temporary reservation when the electric vehicle 100A is sufficiently approached the temporarily reserved charging facility 300.

This configuration allows a probability that the charging facility 300 is used as scheduled from the use start time to be higher, which helps to improve the operation efficiency of the charging facility 300.

Further, in the above-described charging facility reservation system 1, the route calculator 120, the expected arrival time calculator 140, and the processor 150 may be provided in the electric vehicle 100. However, in the charging facility reservation system 1A, they are not provided in the electric vehicle 100A but are provided in the server 200A.

This configuration eliminates the necessary to provide the route calculator 120, the expected arrival time calculator 140, and the processor 150 in each of the electric vehicles 100A, which helps to reduce costs of the electric vehicles 100A.

In addition, this configuration reduces the electric power to be consumed by the route calculator 120, the expected arrival time calculator 140, and the processor 150, which helps to extend the distance in which the electric vehicle 100A is able to cruise.

### First Modification Example

In the charging facility reservation system 1 or 1A, when the temporary reservation is cancelled, the route calculator 120 or 120A may calculate again a traveling route along which the charging facility 300 is set as the stopover point, and execute the process of temporarily reserving the charging facility 300 set as the new stopover point.

This configuration temporarily reserves again another charging facility 300 that is at the distance in which the electric vehicle 100 is able to cruise when the temporary reservation is cancelled, which helps to allow the driver to continue driving without worrying about the state of charge.

In addition, upon making the new temporary reservation, the use scheduled time of the charging facility 300, or a charging time, is changed based on the state of charge of the storage battery at the time of the cancellation of the temporary reservation. This configuration helps to secure a charging time that compensates for an amount of charging that is based on the cancellation of the temporary reservation.

### Second Modification Example

In the charging facility reservation system 1, the processor 150 may execute the process of canceling all of the temporary reservation when the expected arrival time calculated by the expected arrival time calculator 140 exceeds the use start time set when the temporary reservation is made. In some embodiments, the processor 150 may execute a process of canceling a part of the temporary reservation.

For example, as illustrated in FIG. 4, when the temporary reservation of the charging facility 300_1 is being made from 0:40 AM to 1:40 AM and where the expected arrival time calculated by the expected arrival time calculator 140 is 1:00 AM, the processor 150 may execute a process of changing the use start time from 1:00 AM or later. In one example, the processor 150 may change the temporary reservation to a time period of 1:40 AM from 1:00 AM.

The processor 150 may execute a process of canceling a reservation frame that is before the expected arrival time calculated by the expected arrival time calculator 140.

This configuration allows the electric vehicle 100 to perform charging at the charging facility temporarily reserved, even when it is not possible or difficult for the electric vehicle 100 to arrive at the charging facility 300 by the use start time temporarily reserved due to, for example, traffic congestion.

In addition, this configuration allows another electric vehicle 100 to use a part of the reservation frame that has been temporarily reserved, which helps to improve the operation efficiency of the charging facility 300.

### Third Modification Example

In the charging facility reservation system 1, when the expected arrival time calculated by the expected arrival time calculator 140 is earlier than the use start time set upon making the temporary reservation, the processor 150 may confirm a reservation status of the charging facility 300, and may execute a process of advancing the reservation frame when it is possible to advance the use start time.

For example, as illustrated in FIG. 4, when the temporary reservation of the charging facility 300_1 is being made from 0:40 AM to 1:40 AM and where the expected arrival time calculated by the expected arrival time calculator 140 is 0:10 AM, the processor 150 may confirm a reservation status of the charging facility 300_1, and execute a process of advancing the reservation frame when it is possible to advance the use start time. In one example, the processor 150 may advance the temporary reservation to a time period of 1:10 AM from 0:10 AM.

This configuration prevents an occurrence of wasteful waiting time at the charging facility 300, which helps to allow the occupant of the electric vehicle 100 to arrive at the destination earlier.

In some embodiments, it is possible to implement the electric vehicle 100 of the example embodiment of the disclosure by recording the process to be executed by a processor such as the route calculator 120, the expected arrival time calculator 140, or the processor 150 on a non-transitory recording medium readable by a computer system, and causing the computer system to load the program recorded on the non-transitory recording medium onto the processor such as the route calculator 120, the expected arrival time calculator 140, or the processor 150 to execute the program. The computer system as used herein may encompass an operating system (OS) and a hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

One or more of the route calculator, the expected arrival time calculator, the processor, reservation manager, and the server processor illustrated in FIGS. 2, 3, 7, and 8 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of one or more of the route calculator, the expected arrival time calculator, the processor, reservation manager, and the server processor. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of one or more of the route calculator, the expected arrival time calculator, the processor, reservation manager, and the server processor illustrated in FIGS. 2, 3, 7, and 8.

1. A charging facility reservation system comprising:
an electric vehicle that comprises
a route calculator configured to calculate a traveling route along which a charging facility is set as a stopover point, based on a distance in which the electric vehicle is able to cruise,
a current position obtainer configured to acquire a current position of the electric vehicle,
an expected arrival time calculator configured to calculate an expected arrival time at which the electric vehicle is expected to arrive at the charging facility, based on the current position of the electric vehicle, and
a processor configured to make a temporary reservation of the charging facility set as the stopover point by the route calculator, and cancel all or a part of the temporary reservation when the expected arrival time exceeds a use start time of the charging facility set upon making the temporary reservation; and
a server that is communicably coupled to the electric vehicle and comprises
a transceiver configured to transmit and receive reservation data on the temporary reservation of the charging facility, and
a reservation manager configured to manage use reservation of the charging facility, based on the reservation data.

2. An electric vehicle comprising:
a route calculator configured to calculate a traveling route along which a charging facility is set as a stopover point, based on a distance in which the electric vehicle is able to cruise;
a current position obtainer configured to acquire a current position of the electric vehicle;
an expected arrival time calculator configured to calculate an expected arrival time at which the electric vehicle is expected to arrive at the charging facility, based on the current position of the electric vehicle; and
a processor configured to make a temporary reservation of the charging facility set as the stopover point by the route calculator, and cancel all or a part of the temporary reservation when the expected arrival time exceeds a use start time of the charging facility set upon making the temporary reservation.

3. A charging facility reservation system comprising:
an electric vehicle that comprises a current position obtainer configured to acquire a current position of the electric vehicle; and
a server that is communicably coupled to the electric vehicle and comprises
a transceiver configured to receive data on a distance in which the electric vehicle is able to cruise and data on the current position of the electric vehicle,
a route calculator configured to calculate a traveling route along which a charging facility is set as a stopover point, based on the distance in which the electric vehicle is able to cruise,
an expected arrival time calculator configured to calculate an expected arrival time at which the electric vehicle is expected to arrive at the charging facility, based on the current position of the electric vehicle,
a server processor configured to make a temporary reservation of the charging facility set as the stopover point by the route calculator, and cancel all or a part of the temporary reservation when the expected arrival time exceeds a use start time of the charging facility set upon making the temporary reservation, and
a reservation manager configured to manage use reservation of the charging facility, based on reservation data on the temporary reservation derived from the server processor.
